(19) United States
(12) Patent Application Publication
(10) Pub. No.: US 2010/0038191 A1
(43) Pub. Date: Feb. 18, 2010

(54) MODULAR ACTUATOR FOR WIND TURBINE BRAKE

(76) Inventors: Michael O. Culbertson, Cuyahoga Falls, OH (US); Nicholas Bavaro, Medina, OH (US); David A. Koch, Lodi, OH (US); Thomas L. Soldat, Medina, OH (US); Gilbert Roderiguez, Strongville, OH (US)

Correspondence Address: CHRISTOPHER H. HUNTER, PARKER-HANFIN CORPORATION, 6035 PARKLAND BOULEVARD, CLEVELAND, OH, 44124-4141, US

(21) Appl. No.: 12/541,487

(22) Filed: Aug. 14, 2009

Related U.S. Application Data
(60) Provisional application No. 61/089,066, filed on Aug. 15, 2008.

(51) Int. Cl. F16D 55/225

(52) U.S. Cl. 188/72.6

(57) ABSTRACT

A brake comprising a caliper assembly; brake linings associated with the caliper assembly; and one of an electromechanical actuator module or a hydraulic actuator module. The body of the caliper assembly has a mounting wherein the module(s) can be removably mounted to the caliper without requiring modification to the caliper assembly. The mounting enables the actuator modules to be quickly changed out with a new actuator in the case of repair or maintenance; as well as facilitates initial assembly and upgrades to the brake.

### CROSS-REFERENCE TO RELATED CASES

The present application claims the benefit of the filing date of U.S. Provisional Application Ser. No. 61/089,066; filed Aug. 15, 2008, the disclosure of which is expressly incorporated herein by reference.

### TECHNICAL FIELD

The present invention relates to braking systems for wind turbines, and in particular, to a modular actuator for a wind turbine brake.

### BACKGROUND

The primary braking system for most modem wind turbines is the aerodynamic braking system, which essentially consists in turning the rotor blades about 90 degrees along their longitudinal axis to the wind direction (in the case of a pitch controlled turbine or an active stall controlled turbine ), or in turning the rotor blade tips 90 degrees (in the case of a stall controlled turbine) to the wind. A mechanical brake is used as a backup system for the aerodynamic braking system; and as a parking brake, once the turbine is stopped in the case of a stall-controlled turbine. In the case an emergency where immediate braking of the wind turbine is needed, the mechanical brake can be activated simultaneously with the aerodynamic brakes. The mechanical brake typically comprises two hydraulically actuated calipers that engage a disk on the shaft that connects the gearbox and generator. It is also known to provide electromechanical actuators to control the movement of the calipers.

Current hydraulic wind turbine brakes require the brake to be removed from the wind turbine and disassembled in order to replace worn seals and other components in the actuator. The brake weight and mounting location can make changing out the components difficult and costly. Each brake weighs between 200-500 lbs and can be located in a tower in excess of 300 feet above the ground.

### SUMMARY

At least one embodiment of the invention provides a brake comprising a caliper assembly; brake linings associated with the caliper assembly; and one of an electromechanical actuator module or a hydraulic actuator module; the caliper assembly having a mounting wherein the module(s) can be easily and simply removably mounted to the caliper assembly without requiring modification to the caliper assembly.

The body of the caliper assembly includes a circular mounting opening into a central cavity of the body. An annular flat mounting surface surrounds the opening, and an annular sidewall bounds the mouth of the opening and projects from the opening into the central cavity. The mounting surface of the module is mounted flush against the mounting surface of the caliper body, and an actuator of the module projects into the mounting opening and engages and moves one of the brake linings during use.

The mounting enables the actuator module to be quickly changed out with a new actuator in the case of repair or maintenance; as well as facilitates initial assembly and upgrades to the brake.

### BRIEF DESCRIPTION OF THE DRAWINGS

Embodiments of this invention will now be described in further detail with reference to the accompanying drawing, in which:

FIG. 1 is a perspective view of a brake for a wind turbine application constructed according to the principles of the present invention, including a caliper assembly and a hydraulic actuator;

FIG. 2 is a perspective view of the caliper assembly of FIG. 1, shown with the actuator removed;

FIG. 3 is a front plan view of the brake of FIG. 1;

FIG. 4 is a cross-sectional side view of the brake of FIG. 3, taken substantially along the plane defined by the lines 4-4 of FIG. 3;

FIG. 5 is a cross-sectional side view of the brake of FIG. 3, taken substantially along the plane defined by the lines 5-5 of FIG. 3;

FIG. 6 is a perspective view of the brake of FIG. 1, shown with an electromechanical actuator module mounted to the caliper assembly; and

FIG. 7 is a sectional perspective view of the electromechanical actuator brake showing the interior of the actuator in FIG. 6.

### DETAILED DESCRIPTION OF THE PREFERRED EMBODIMENT

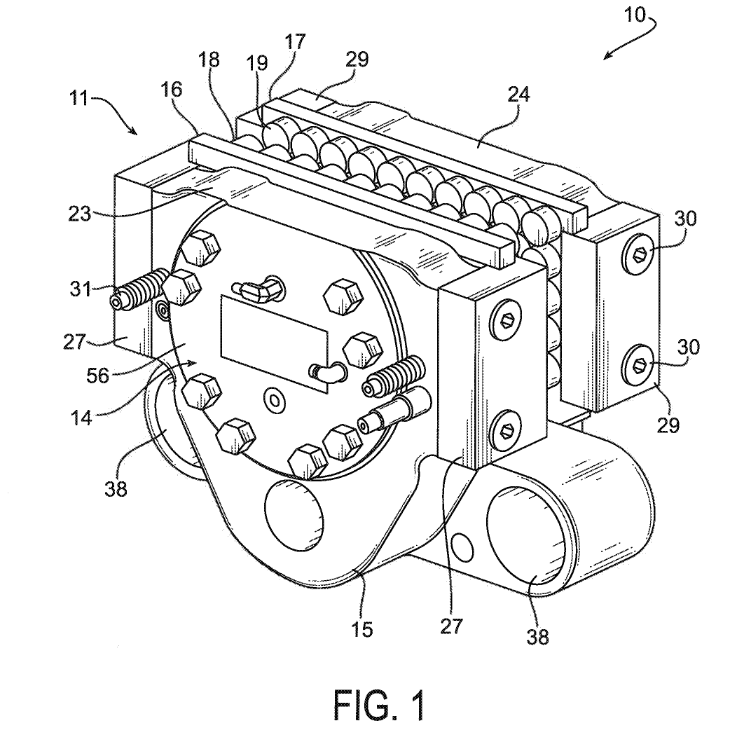

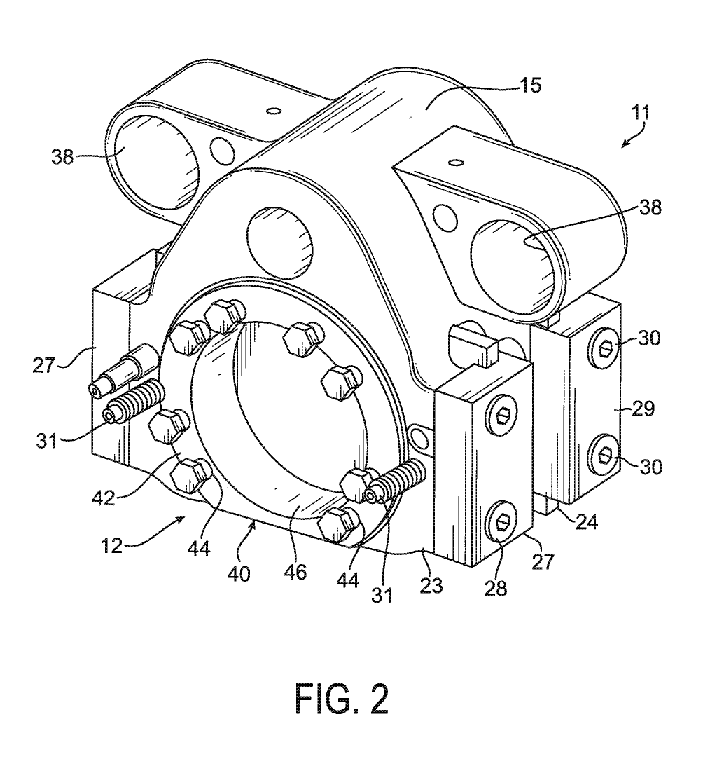

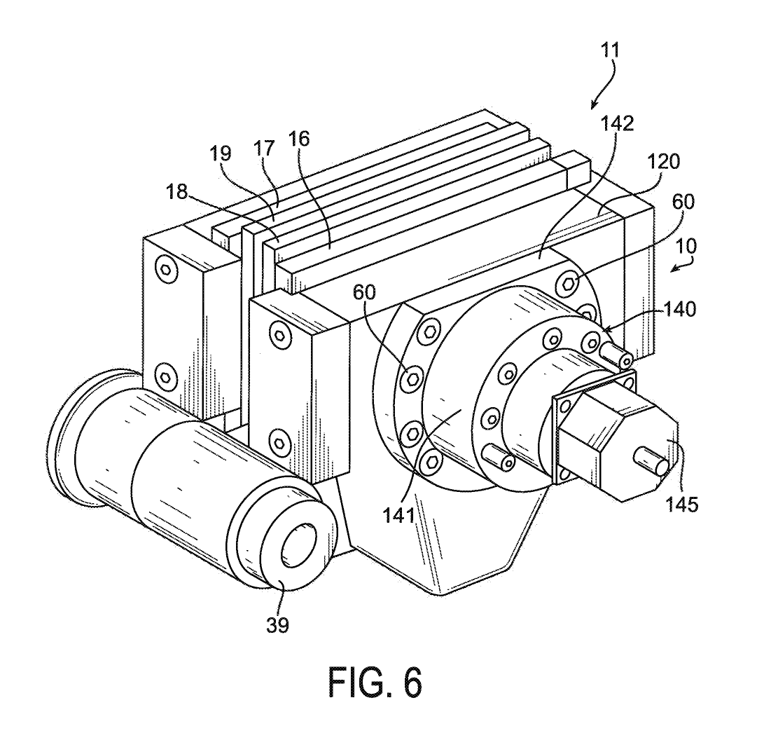

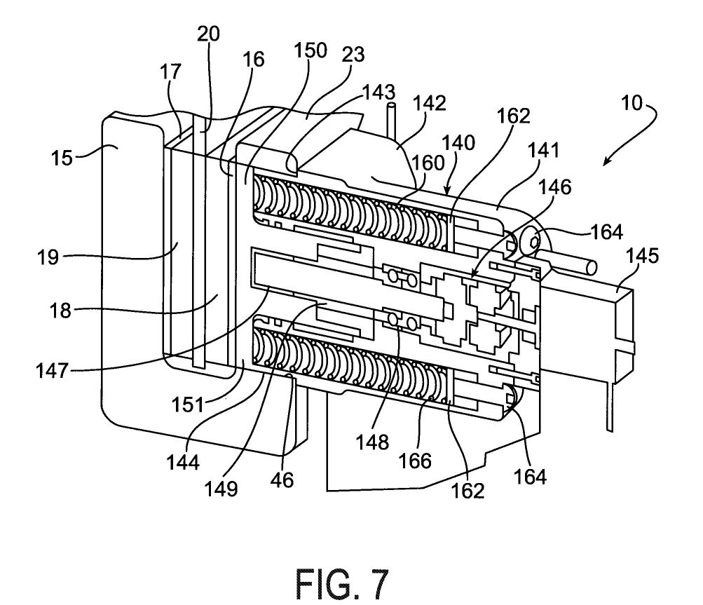

Referring initially to FIGS. 1 and 2, a brake constructed according to the principles of the present invention is indicated generally at 10, and includes a caliper assembly indicated generally at 11, having a mounting, indicated generally at 12, for an actuator, indicated generally at 14. As will be described in greater detail below, the actuator 14 in a first embodiment described herein is a hydraulic actuator; while in another embodiment illustrated in FIGS. 6 and 7, the actuator (indicated generally at 140) can be an electromechanical actuator. It should be appreciated that in a general sense, any appropriate actuator may be used with the caliper assembly for controlling the brake, and the present invention is not limited to the particular hydraulic and electromechanical actuators described herein, as should be appreciated by those skilled in the art.

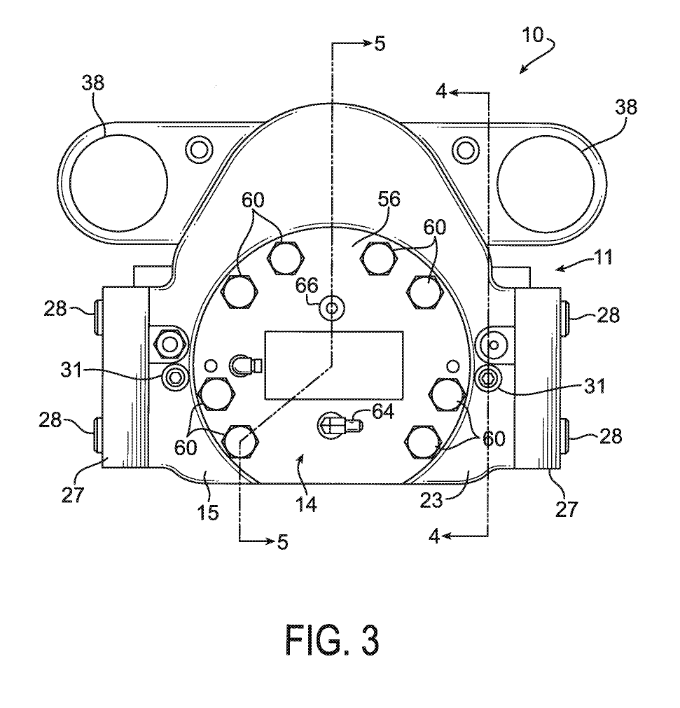

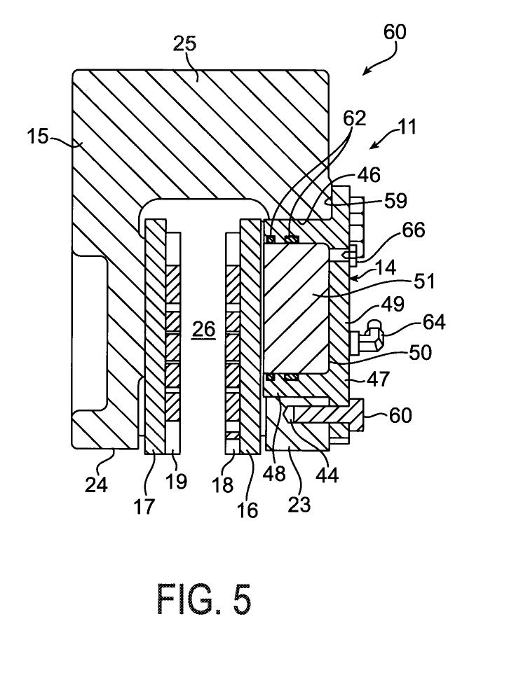

Referring to FIGS. 1-5, the caliper assembly 11 includes a body 15 supporting a pair of calipers blades or plates 16, 17, in parallel relation to each other, and each of which includes a friction lining 18, 19, respectively, fixed to its inner surface. The linings 18, 19 are configured to engage and disengage a rotating disk 20 (FIG. 7) centrally located between the linings to slow or stop the rotation of the disk. Disk 20 is associated with a shaft that connects a gearbox and generator in a wind turbine, such as shown and described for example, in U.S. Pat. Nos. 4,423,333; 7,436,083; and 7,075,192, which are incorporated herein by reference.

The body 15 for the caliper assembly has a generally C-shaped configuration, with generally parallel and spaced-apart first and second sidewalls 23, 24 and an end wall portion 25 defining a central cavity, indicated generally at 26. A pair of end brackets or stops 27 are mounted via bolts 28 to opposite ends of sidewall 23; while a pair of end brackets or stops 29 are likewise mounted via bolts 30 to opposite ends of sidewall 24. Stops 27 and 29 locate and guide the caliper blades with respect to the respective sidewalls 23, 24 of the caliper body, and absorb the reaction load of the friction linings during use.

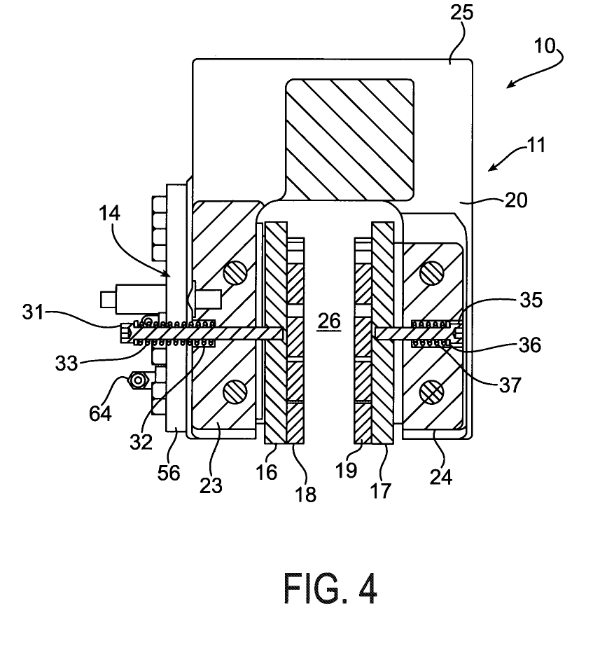

The caliper blade 16 and associated brake lining 18 are supported and held against sidewall 23 via a pair of return bolts 31 (FIG. 4) projecting through lateral apertures 32 in the sidewall and into blind-end threaded bores in the outer surface of caliper blade 16. A return spring 33 is located around each bolt 31 and compresses between an inner shoulder of the aperture and an enlarged head of the bolt, to urge the caliper blade 16 against the inner surface of the sidewall 23—but to also allow the caliper blade to move inwardly away from the sidewall under the influence of the actuator, as will be describe below. The caliper blade can also float somewhat if necessary to match the surface geometry and orientation of the brake disk during use.

Caliper blade 17 and associated brake lining 19 are likewise supported and held against sidewall 24 via a pair of return bolts 35 (FIG. 4) projecting through lateral apertures 36 in the sidewall and into blind-end threaded bores in the outer surface of caliper blade 17. A spring 36 is located around each bolt 35 and compresses between an inner shoulder of the aperture and an enlarged head of the bolt, to force the caliper blade 17 against the inner surface of the sidewall 24—but again, to also allow the caliper to float somewhat if necessary to match the surface geometry and orientation of the brake disk.

A pair of bushings 38 are provided in caliper body 15, which receive torque pins (for example as shown at 39 in FIG. 6) to mount the caliper assembly on an appropriate support surface in the turbine cowl. A “floating” mount can be used, where the brake includes spherical bearings which are supported for axial and angular movement on the torque pins, such as shown and described in U.S. patent application Ser. No. ______, to Culbertson for “Floating Yaw Brake for Wind Turbine”, filed concurrently herewith, and which is incorporated herein by reference.

Referring now to FIG. 2, mounting 12 includes a circular opening, indicated generally at 40, with a flat, mostly annular mounting surface 42, surrounding the opening and being slightly raised from the surface of the body. A series of threaded bolts holes 44 are arranged around the mounting surface and extend into the caliper body for mounting the actuator, as will be described below in more detail. An annular sidewall 46 inwardly bounds the opening 40, and extends inwardly from the mounting surface 42 into the cavity 26 of the caliper body. Opening 40 is located centrally in the caliper body 15, and extends laterally through the body, with a return bolt 31 located on opposite sides of the opening.

As shown in FIGS. 1 and 3-5, hydraulic actuator module 14 fits closely within opening 40 and is fixed, e.g., bolted to the caliper body 15. To this end, module 14 includes a cylinder body 47 having an annular sleeve 48 and an end wall or plate 49, together which form a chamber 50. A cylindrical piston 51 is closely and slidingly received within sleeve 48 of cylinder body 47. The sleeve 48 of the cylinder body has an outer diameter that fits closely within the circular opening 46 in the caliper body 15. Plate 49 has an inner annular and flat mounting surface 59 that fits flush against the outer flat mounting surface 42 of the mounting for the caliper body when the actuator is assembled within the opening 40. Plate 56 also includes holes corresponding to threaded holes 44 in the mounting surface of the caliper body, and in which bolts 60 are received to mount actuator 14 to caliper body 15. Mounting bolts 60 are spaced around the plate 49 to ensure a close, rigid attachment of the actuator to the mount 12 of the caliper body.

Annular seals 62 are carried within channels formed in the inner surface of sleeve 48 and provide a seal against the outer diameter of piston 51. Piston 51 has a length such that it essentially fills chamber 50 and normally engages against the inside surface of caliper blade 16 when the cylinder body is mounted to the caliper body. The close fit of the cylinder body within the opening 46 ensures that the piston is properly located with respect to the caliper blade, and ensures standard assembly and repeatable operation. A high pressure inlet port 64 is formed at one appropriate location in the end plate 47 of the cylinder body, while a high pressure outlet port 66 is formed at another appropriate location. Each of the inlet and outlet ports are attached to appropriate tubing and direct hydraulic fluid into and out of the inner end of piston chamber 50 to appropriately move the piston 51. Directing hydraulic fluid through inlet port 64 into the chamber 50 increases the pressure against the inside end of the piston and moves piston 51 against caliper plate 16; to move plate 16, and hence friction lining 18, inwardly away from sidewall 23 and against the disk. Directing fluid out of outlet port 66 reduces pressure against the inside end of piston, which allows the return spring 33 to move the caliper plate away from the disk and toward the sidewall 23. Systems for controlling the flow of fluid into and out of the ports 64, 66 under pressure are well known to those skilled in the art and will not be described herein for sake of brevity. Again, seals 62, in conjunction with the close fit of piston 51 within sleeve 48, ensure the hydraulic fluid is contained, and does not leak during actuator mounting or removal from the caliper body. All components of the module are removed together as a unit when the module is removed from the mounting on the caliper assembly.

As described above, the hydraulic module is a compact, self-contained component that can be easily assembled and mounted to the caliper body in a rigid manner, using only a few standard bolts and standard tools. Likewise, if servicing of the hydraulic actuator module is needed, standard tools can be used to remove the bolts 60 and hydraulic actuator module 14 can be simply and easily removed from the caliper body 15—while the caliper assembly otherwise remains installed on the wind turbine. This allows seal repair and/or replacement, or complete hydraulic module replacement, on-site, if needed.

Referring now to FIGS. 6 and 7, a further embodiment of an actuator for a wind turbine brake is shown. In this embodiment, the brake 10 includes an electromechanical actuator module, indicated generally at 140, mounted to the caliper assembly 11. The electromechanical actuator module 140 is attached to the caliper assembly 110 by bolts 60, as in the first embodiment described above. To this end, actuator module 140 includes a body 141 having an annular, radially-projecting base 142 with a flat annular mounting surface 143. Bolts 60 are received through openings in annular base 142 of the actuator module, and are received in the threaded apertures 44 (FIG. 2) in the caliper body to attach the mounting surface 143 of the actuator in a rigid manner against the mounting surface 42 (FIG. 2) of the caliper body. As in the first embodiment, the inner end 144 of actuator body 141 has an annular configuration which is closely received within the sidewall 46 of the caliper body 15.

As shown primarily in FIG. 7, the electromechanical actuator 140 comprises a motor 145 coupled to a gear system 146, with the gear system 146 directly coupled to a ball screw 147. Ball bearing bushings 148 support the rotational movement of ball screw 147 within actuator body 141. The ball screw 147 can be a high efficiency ball screw, which allows the use of inexpensive dowel pins to be used to prevent rotation of the pusher piston 150 instead of expensive splines. Rotation of the ball screw 147 causes a ball screw nut 149 to move a pusher piston 150 toward or away from caliper plate 16. The gear system 146 can be a two-stage 25:1 planetary gear which, along with the high efficiency ball screw, allows for smaller motor torque requirement. The pusher piston 150 has an end plate 151 the rear surface of which is acted upon by at least one, and preferably eight evenly-spaced apart compression springs 160 laterally supported within body 141. Compression springs 160 cause the pusher piston 150 to move evenly toward the disk 20 to engage the brake 10 by creating a clamping load on the linings 18, 19 and the disk 20.

During operation, the brake 100 is disengaged by the electromechanical actuator 140 which retracts the pusher piston 150 away from the disc 20 and compresses the springs 160. In a stopping situation, the actuator 140 can move the pusher piston 150 toward the disc 20 to allow the compression springs 160 to extend and provide a clamping force to stop or slow the disk 20. If additional clamping force is required, the actuator 140 can provide additional force against the pusher piston 150 to assist the springs 160.

Accordingly, the brake 10 provides a hybrid passive and active brake system by providing the “fail safe” of the spring 160 and using the electromechanical force of the actuator 140 to increase the clamping force beyond the spring force. In the same manner, the clamping force can be controlled by incrementing the motor and using an encoder or strain gauge to provide a closed loop control of the braking. Use of an encoder also allows the brake 10 to compensate for the decrease in spring force caused by lining wear and provides the actual wear and lining thickness.

In the embodiment shown in FIG. 7, the spring force provided by the compression spring(s) 160 is adjustable. The end of the spring 160 is held in place by a disc 162 in the spring cylinder that is held in place by a set screw 164. The spring force can be reduced by adding washers underneath one or more of the set screw heads which will also provide a visual indication for spring force setting by means of washers. In the embodiment shown, the spring force can be modified down to 50% of nominal torque.

As with actuator 14 in the first embodiment, actuator 140 is also self-contained, that is, actuator body 140 encloses all the major components of the actuator (except motor 144 which is mounted to the body), and all components of the module are removed together as a unit when the module is removed from the mounting on the caliper assembly.

In any of the embodiments describe above, the modular mounting technique of the actuator to the caliper assembly provides multiple choices for brake actuation, depending on the specific need (e.g. electrical versus hydraulic power supply, safety considerations, etc.). This modular approach allows a single casting, which comprises the heavy structural portion of the brake, to be used for multiple types of brakes. This can improve the economy of scale for the casting and brake structure, which is one of the higher cost components of the brake assembly.

As should be appreciate from the above, the brake assembly of the present invention provides numerous improvements such as: i) maintenance—the brake can remain mounted on the wind turbine when the seals are replaced and the cylinder sleeve eliminates potential piston wear against the structural portion of the brake assembly, to maximize the life of the costly/heavy brake structure; ii) modularity of the actuator—the brake structure remains the same for different actuator types and the modular actuator can be mounted on the same brake structure and bolt hole pattern; iii) economy of scale—multiple actuator types can be used on the same brake structure which allows lower unit cost due to of higher quantities; and iv) lower machine cost—the opening for the modular actuator allows the machining of the opposite face which eliminates one machine setup cost.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention. Accordingly, the scope and content of the present invention are to be defined only by the terms of the appended claims.

What is claimed is:

1. A brake comprising:
a caliper assembly;
brake linings associated with the caliper assembly;
one of an electromechanical actuator module or a hydraulic actuator module;
the caliper assembly having a mounting wherein the electromechanical actuator module or hydraulic actuator module can be selectively mounted to the caliper assembly without requiring modification to the caliper assembly.

2. The brake of claim 1, wherein the actuator is a self-contained electromechanical actuator.

3. The brake of claim 1, wherein the actuator is a self-contained hydraulic actuator.

4. A brake for a wind turbine, comprising:
a caliper assembly including a central cavity;
brake linings supported in the cavity of the caliper assembly;
one of an electromechanical actuator module or a hydraulic actuator module;
the caliper assembly having a mounting opening with an annular mounting surface surrounding the opening, and an annular sidewall bounding an inner diameter of the opening and projecting from the opening into the central cavity; wherein the respective module can be selectively mounted to the mounting surface of the caliper assembly with an actuator component of the respective module projecting into the mounting opening for engaging one of the brake linings, without requiring modification to the caliper assembly.

5. The brake as in claim 4, wherein the respective module also includes a mounting surface, and the mounting surface of the module can be located flush against the mounting surface of the caliper assembly.

6. The brake as in claim 4, wherein the actuator component is a piston.

7. A brake for a wind turbine, comprising:
a caliper assembly including a central cavity;
brake linings supported in the cavity of the caliper assembly;
an actuator module including an annular mounting surface, and an actuator piston;
the caliper assembly having a mounting opening into the cavity, a mounting surface surrounding the opening, and a sidewall bounding the mouth of the opening and projecting from the opening into the central cavity, wherein the mounting surface of the module is mounted flush against the mounting surface of the caliper assembly, and the actuator piston of the module projects into the mounting opening and can engage one of the brake linings during use.
